(19) United States
(12) Patent Application Publication
(10) Pub. No.: US 2016/0189170 A1
(43) Pub. Date: Jun. 30, 2016

(54) Recognizing Customers Requiring Assistance

(71) Applicant: International Business Machines Corporation, Armonk, NY (US)

(72) Inventors: Sima Nadler, Kochav Yair (IL); Tali Yatzkar-Haham, Yaad (IL)

(21) Appl. No.: 14/583,821

(22) Filed: Dec. 29, 2014

(51) Int. Cl. G06Q 30/02; G06Q 30/06; G06Q 30/00

(52) U.S. Cl. CPC G06Q 30/02; G06Q 30/01; G06Q 30/0601

(57) ABSTRACT

A method of recognizing customers requiring assistance, comprising: tracking movement of a customer at a store by at least one sensor; identifying at least one movement pattern from the tracking; analyzing the at least one movement pattern to identify a potential requirement of assistance by the customer; sending a message indicative of the potential requirement to an assisting system of the store; and triggering a providing of the assistance to the customer.

### BACKGROUND

The present invention, in some embodiments thereof, relates to customer assistance and, more specifically, but not exclusively, to recognizing customers needing assistance, guidance, or support using pattern analysis.

Retailers want to serve their customers better in order to increase sales. Some methods include tracking of customers and their behavior in various was, such as location, previous purchases and other information. This information is mostly used to provide customers with promotional information.

### SUMMARY

According to an aspect of some embodiments of the present invention there is provided a method of recognizing customers requiring assistance, comprising: tracking movement of a customer at a store by at least one sensor; identifying at least one movement pattern from the tracking; analyzing the at least one movement pattern to identify a potential requirement of assistance by the customer; sending a message indicative of the potential requirement to an assisting system of the store; and triggering a providing of the assistance to the customer.

Optionally, product information stored in a dataset is used for the analyzing.

Optionally, customer information stored in a dataset is used for the analyzing.

Optionally, statistical movement pattern information stored in a dataset is used for the analyzing.

Optionally, the at least one identified movement pattern is saved to be used in future recognizing of customers requiring assistance.

Optionally, data of the analyzing is saved to be used in future recognizing of customers requiring assistance.

Optionally, the at least one sensor is embedded in a mobile device used by the customer.

Optionally, the at least one sensor is at least one video capturing device.

Optionally, the at least one sensor is at least one motion detection sensor.

Optionally, the triggering includes determining the method of the providing by using information stored in a dataset.

Optionally, the triggering includes determining that providing the assistance to the customer is cost effective by using information stored in a dataset.

Optionally, the providing includes sending an employee of the store to the customer.

More optionally, the sending includes providing the employee a photograph of the customer.

Optionally, the providing includes providing the assistance via a mobile device of the customer.

According to some embodiments of the present invention there is provided a computer readable medium comprising computer executable instructions adapted to perform the method.

According to an aspect of some embodiments of the present invention there is provided a method of recognizing customers requiring assistance, comprising: tracking browsing of a customer at an online store; identifying at least one browsing movement pattern from the tracking; analyzing the at least one browsing movement pattern to identify a potential requirement of assistance by the customer; sending a message indicative of the potential requirement to an assisting system of the online store; and triggering a providing of the assistance to the customer.

According to an aspect of some embodiments of the present invention there is provided a system for recognizing customers requiring assistance, comprising: at least one sensor that tracks movement of a customer at a store; a pattern analysis module that identifies at least one movement pattern from the tracking and analyzes the at least one movement pattern to identify a potential requirement of assistance by the customer; and an assisting system that receives a message indicative of the potential requirement and triggers a providing of the assistance to the customer.

According to an aspect of some embodiments of the present invention there is provided a computer program product for recognizing customers requiring assistance, comprising: a computer readable storage medium; first program instructions to track movement of a customer at a store using at least one sensor; second program instructions to identify at least one movement pattern from the tracking; third program instructions to analyze the at least one movement pattern to identify a potential requirement of assistance by the customer; fourth program instructions to send a message indicative of the potential requirement to an assisting system of the store; and fifth program instructions to trigger a providing of the assistance to the customer; wherein the first, second, third, fourth and fifth program instructions are stored on the computer readable storage medium.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart schematically representing a method for recognizing customers requiring assistance, according to some embodiments of the present invention;

FIG. 2 is a schematic illustration of a system for recognizing customers requiring assistance, according to some embodiments of the present invention; and

FIG. 3 is a schematic illustration of an exemplary movement pattern of a customer walking in a store, according to some embodiments of the present invention;

FIG. 4 is a flowchart schematically representing an exemplary logical process of recognizing customers requiring assistance, according to some embodiments of the present invention.

### DETAILED DESCRIPTION

The present invention, in some embodiments thereof, relates to customer assistance and, more specifically, but not exclusively, to recognizing customers needing assistance, guidance, or support using pattern analysis.

According to some embodiments of the present invention, there is provided a method for recognizing customers needing assistance by tracking and analyzing movement patterns of a customer in a store or browsing patterns in an online store. The analysis provides indication of whether the customer needs assistance and/or information, or may indicate what kind of promotional information is relevant for the customer at that time. The analysis may include information stored in a dataset, such as product information, customer information and/or previous analysis.

When applied, the method includes tracking movement of a customer at a store by sensor(s) such as imaging and/or motion sensors, identifying movement pattern(s) using algorithm(s) that analyze the data from the sensor(s), analyzing and/or classifying the movement pattern(s) to identify a potential requirement of assistance by the customer, sending a message indicative of the potential requirement to an assisting system and triggering a providing of the assistance to the customer.

The tracking data, recognized patterns and/or analysis results may be stored to improve the algorithms used for the analysis in order to provide better performance in future analysis.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

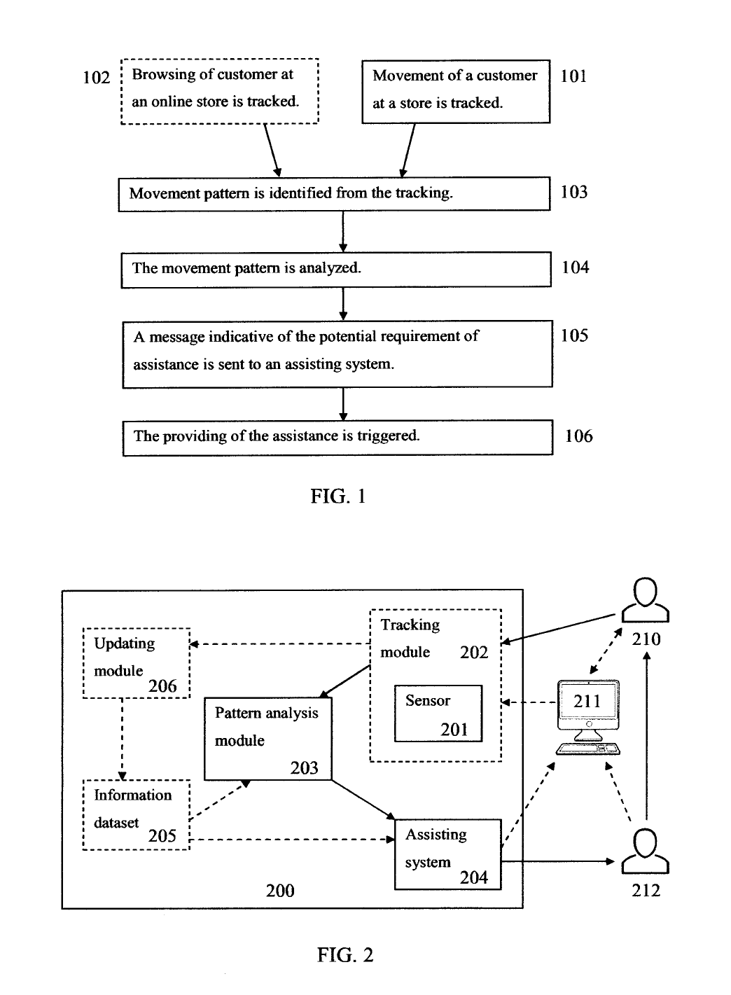

Referring now to the drawings, FIG. 1 is a flowchart schematically representing a method for recognizing customers requiring assistance, according to some embodiments of the present invention. Reference is also made to FIG. 2, which is a schematic illustration of a system 200 for recognizing customers requiring assistance based on analyzed movement patterns, according to some embodiments of the present invention.

System 200 may be partly implemented on a computer hardware unit or a program installed on an enterprise server, workstation, personal computer, and/or any other platform.

First, as shown at 101, movement of a customer 210 at a store is tracked by sensor(s) 201 by detecting the customer and acquiring data of his location at different times. Optionally, sensor(s) 201 is a part of tracking module 202. Tracking module 202 may be, for example, a software module embedded in system 200, and/or a hardware device. The store may be any kind of physical retail facility where customers may move around, or may be a virtual store, for example using virtual reality technologies.

Sensor(s) 201 may be, for example, Bluetooth low energy beacons, Wireless Fidelity (WiFi™) sensors, video capturing equipment such as a camera or a network of cameras, motion detection sensor(s), proximity sensor, light flicker and/or any other sensor installed in the store. Sensor(s) 201 may also be embedded in a mobile device, for example, a dedicated shopping device and/or a personal mobile device of customer 210 such as a mobile phone or tablet computer. Sensor(s) 201 may then include a global positioning system (GPS), cellular network and/or local wireless network devices that perform location triangulation and/or any other device.

Alternatively, as shown at 102, browsing of customer 210 at an online store is tracked by tracking module 202. The online store may be any kind of internet website having products and/or services available for online purchase. Customer 210 uses a terminal 211, which may be, for example, a personal computer, a mobile computer, a tablet computer and/or a mobile phone. Tracking module 202 may be, for example, a software module embedded in system 200 and/or in the browsing utility used by customer 210 to browse the online store. Tracking module 202 may collect, by copying and saving, information such as pages viewed by customer 210, duration of viewings of each product and/or order of viewed products.

Then, as shown at 103, a movement pattern is identified from the tracking by a pattern analysis module 203. Pattern analysis module 203 may be a software module implemented in system 200 or a hardware unit connected to sensor(s) 201 and/or tracking module 202 via a network. Pattern analysis module 203 may include an algorithm. The network may be of any kind, for example, a local area network (LAN), wireless local area network (WLAN) protocol such as Wireless Fidelity (WiFi™), a wireless personal area network (WPAN) such as Bluetooth™ protocol, private radio network, cellular network or any other form of communication.

Pattern analysis module 203 may include an algorithm for identifying the movement pattern from the data provided by sensor(s) 201 and/or tracking module 202. The movement pattern may be, for example, extended dwell time of customer 210 at a specific location or different locations in the store, repeat visits to a particular location in the store, movement back and forth between locations in the store, movement in a circular pattern, change in speed of movement, typical paths, unique paths, different amounts of time spent at some locations, repetitive paths and/or any other pattern.

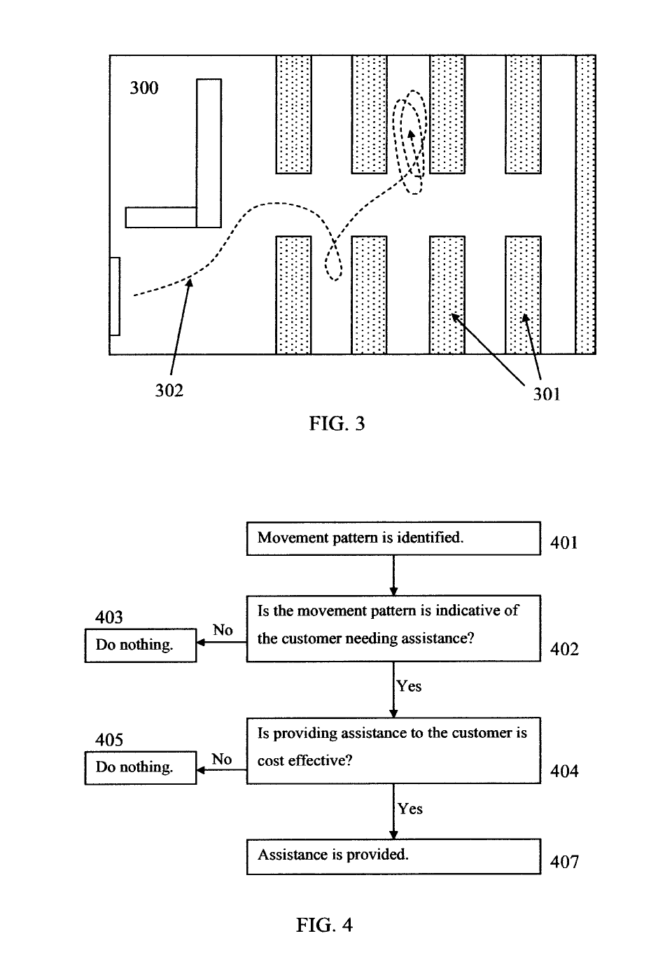

Reference is now made to FIG. 3, which is a schematic illustration of an exemplary movement pattern 302 of a customer walking in a store 300, according to some embodiments of the present invention. The customer is walking through the store, between the aisles 301 of the store, from one aisle to another.

Then, as shown at 104, the movement pattern is analyzed by pattern analysis module 203 to identify a potential requirement of assistance by the customer. Pattern analysis module 203 may include an analysis algorithm that matches the identified pattern with a known pattern that is associated with potential requirement of assistance. The assistance may include, for example, additional information such as additional product information, price comparisons, advice on which product to purchase, information about store policies, location of a product in the store, promotional information related to the identified pattern and/or any other information. The assistance may also include physical assistance, such as removing items from a high shelf.

Optionally, several different identified patterns are combined and analyzed by pattern analysis module 203. Optionally, one or more patterns are analyzed in relation to a request of assistance by customer 210.

Optionally, pattern analysis module 203 uses information stored at an information dataset 205. The information may include, for example, information about the location of the products in the store, information about sales for the products in the store, information about typical and/or average movement patterns of customers, information about what items and how often items are inquired and/or viewed by customers (for example by barcode scan and/or image capture), customer information such as typical paths, types of purchases and/or demographical information and/or any other information.

Optionally, data from sensor(s) 201 and/or tracking module 202 is collected at an updating module 206 by copying and saving, which then adds the data to information dataset 205 to be used in future pattern analysis for customer 210 and/or other customers. The data may be manipulated, for example reorganized and/or converted to different formats, before saved in information dataset 205. Optionally, data of identified pattern from pattern analysis module 203 is also collected at updating module 206 and added to information dataset 205.

Then, as shown at 105, a message indicative of the potential requirement of assistance is sent from pattern analysis module 203 to an assisting system 204. Assisting system 204 may be a software module implemented in system 200 or a hardware unit connected to pattern analysis module 203 via a network. The network may be of any kind, as described above. The message includes the identifying information of customer 210 such as identity, image and/or location, and includes the type of assistance to be provided to customer 210. Assisting system 204 may also determine whether or not to provide of the assistance to customer 210 and/or determine the manner of providing the assistance.

Finally, as shown at 106, the providing of the assistance to customer 210 is triggered by assisting system 204. Assisting system 204 may determine whether to provide the assistance and how.

In a physical store, the triggering may include sending a store employee to provide assistance to customer 210 and/or inquire for the assistance he may need. Notifying the store employee may be done, for example, through the store's computer system that is used by store employees, using notifications to a mobile device of the store employee and/or by any other notification. Optionally, the store employee is also provided with means to identify customer 210 from among other customers in the store. The means could be, for example, a photograph of customer 210 and/or an accurate location of customer 210. A photograph of customer 210 may be acquired, for example, from the data collected by sensor(s) 201 when they include imaging sensors and/or an image of customer 210 may be included in the customer information stored in information dataset 205 and automatically extracted.

Reference is now made to FIG. 4, which is a flowchart schematically representing an exemplary logical process of recognizing customers requiring assistance, according to some embodiments of the present invention. First, as shown at 401, movement pattern of customer 210 is identified by tracking module 202. Then, as shown at 402, it is determined by pattern analysis module 203 whether the movement pattern is indicative of customer 210 needing assistance. When it is not, nothing is done, as shown at 403. When it is, as shown at 404, it is determined by assisting system 204 whether providing assistance to customer 210 is cost effective, as shown at 405. When it is not, nothing is done, as shown at 406. When it is, as shown at 407, assistance is provided.

Optionally, information dataset 205 includes information about store employees such as product knowledge areas, work schedule and/or location. This information may be used by assisting system 204 to determine which store employee is sent to assist customer 210. For example, a closest store employee to customer 210 is sent or a store employee that has the most knowledge of the products in the area of the store where customer 210 dwells.

Optionally, assisting system 204 determines whether sending a store employee to assist customer 210 is cost effective, using any kind of information stored at information dataset 205. For example, sending a store employee may not be cost effective when there are few available store employees, when customer 210 is known to rarely make a purchase and/or when the relevant professional products are mostly inquired by non-professional customers.

The triggering may also include providing the assistance electronically, for example, via a screen placed at the store, a dedicated shopping device and/or a personal mobile device of customer 210 such as a mobile phone or tablet computer. Optionally, an inquiry message is sent to customer 210 in order to identify the type of and/or information required by customer 210. Then, the assistance may be provided according to a response message sent by customer 210.

In an online store, the assistance may be provided, for example, as part of the pages viewed by customer 210, by a message on the screen of terminal 211, by suggesting a chat with artificial intelligence software or a human assistant, by suggesting a phone call to the store's customer service and/or by any other method.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems for customer assistance will be developed and the scope of the term customer assistance is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of recognizing customers requiring assistance, comprising:
tracking movement of a customer at a store by at least one sensor;
identifying at least one movement pattern from said tracking;
analyzing said at least one movement pattern to identify a potential requirement of assistance by said customer;
sending a message indicative of said potential requirement to an assisting system of said store; and
triggering a providing of said assistance to said customer.

2. The method of claim 1, wherein product information stored in a dataset is used for said analyzing.

3. The method of claim 1, wherein customer information stored in a dataset is used for said analyzing.

4. The method of claim 1, wherein statistical movement pattern information stored in a dataset is used for said analyzing.

5. The method of claim 1, wherein said at least one identified movement pattern is saved to be used in future recognizing of customers requiring assistance.

6. The method of claim 1, wherein data of said analyzing is saved to be used in future recognizing of customers requiring assistance.

7. The method of claim 1, wherein said at least one sensor is embedded in a mobile device used by said customer.

8. The method of claim 1, wherein said at least one sensor is at least one video capturing device.

9. The method of claim 1, wherein said at least one sensor is at least one motion detection sensor.

10. The method of claim 1, wherein said triggering includes determining the method of said providing by using information stored in a dataset.

11. The method of claim 1, wherein said triggering includes determining that providing said assistance to said customer is cost effective by using information stored in a dataset.

12. The method of claim 1, wherein said providing includes sending an employee of said store to said customer.

13. The method of claim 12, wherein said sending includes providing said employee a photograph of said customer.

14. The method of claim 1, wherein said providing includes providing said assistance via a mobile device of said customer.

15. A computer readable medium comprising computer executable instructions adapted to perform the method of claim 1.

16. A method of recognizing customers requiring assistance, comprising:
tracking browsing of a customer at an online store;
identifying at least one browsing movement pattern from said tracking;
analyzing said at least one browsing movement pattern to identify a potential requirement of assistance by said customer;
sending a message indicative of said potential requirement to an assisting system of said online store; and
triggering a providing of said assistance to said customer.

17. A system for recognizing customers requiring assistance, comprising:
at least one sensor that tracks movement of a customer at a store;
a pattern analysis module that identifies at least one movement pattern from said tracking and analyzes said at least one movement pattern to identify a potential requirement of assistance by said customer; and
an assisting system that receives a message indicative of said potential requirement and triggers a providing of said assistance to said customer.

18. A computer program product for recognizing customers requiring assistance, comprising:
a computer readable storage medium;
first program instructions to track movement of a customer at a store using at least one sensor;
second program instructions to identify at least one movement pattern from said tracking;
third program instructions to analyze said at least one movement pattern to identify a potential requirement of assistance by said customer;
fourth program instructions to send a message indicative of said potential requirement to an assisting system of said store; and
fifth program instructions to trigger a providing of said assistance to said customer;
wherein said first, second, third, fourth and fifth program instructions are stored on said computer readable storage medium.
